(19) United States
(12) Patent Application Publication
(10) Pub. No.: US 2025/0316928 A1
(43) Pub. Date: Oct. 9, 2025

(54) CONNECTOR HAVING RETENTION FEATURE FOR LEVER AND SLIDE MATING ASSIST MECHANISM

(71) Applicant: Aptiv Technologies AG, Schaffhausen (CH)

(72) Inventors: Rangarajan Sundarakrishnamachari, Chennai (IN); Velmurugan Kandasamy, Salem (IN); Daniel Vernon, Youngstown, OH (US)

(21) Appl. No.: 18/625,922

(22) Filed: Apr. 3, 2024

(51) Int. Cl. H01R 13/629

(52) U.S. Cl. CPC H01R 13/62927

(57) ABSTRACT

A connector assembly may include a first connector having a connector housing. An assembly may include a slide assist member slidably connected to the connector housing and having a cam slot. An assembly may include a lever pivotably connected to the connector housing and the slide assist member configured to move the slide assist member relative to the connector housing from a pre-staged location to a staged location. An assembly may include a first latching feature and a second latching feature that cooperate to maintain the slide assist member in the pre-staged location. A connector system and a method of assembling a connector system is also provided.

### TECHNICAL FIELD

This invention is directed to a connector, particularly to a connector having a retention feature for a lever and slide mating assist mechanism.

### BACKGROUND

In conventional connectors with lever and slide mating assist mechanisms, retention features are typically used to secure the slides in a pre-staged position. Existing retention features are capable of withstanding forces of about 15 newtons (N) of force applied to them by the lever and slides. However, these existing retention features do not provide sufficient retention force if the mechanical advantage of the lever is high and exerts forces greater than 15 N on the retention features.

### SUMMARY

In some aspects, the techniques described herein relate to a connector assembly, including: a first connector having a connector housing; a slide assist member slidably connected to the connector housing and having a cam slot; a lever pivotably connected to the connector housing and the slide assist member configured to move the slide assist member relative to the connector housing from a pre-staged location to a staged location; and a first latching feature and a second latching feature that cooperate to maintain the slide assist member in the pre-staged location.

In some aspects, the techniques described herein relate to a connector system, including: a first connector having a connector housing; a second connector configured to mate with the first connector, the second connector defining a post; a slide assist member slidably connected to the connector housing and having a cam slot configured to receive the post; a lever pivotably connected to the connector housing and the slide assist member configured to move the slide assist member relative to the connector housing from a pre-staged location to a staged location, wherein movement of the slide assist member by the lever from the pre-staged location to the staged location draws the first connector together with the second connector; and a first latching feature and a second latching feature that cooperate to maintain the slide assist member in the pre-staged location until the post is received in the cam slot.

In some aspects, the techniques described herein relate to a method of assembling a connector system, including: providing a first connector having a connector housing, a slide assist member slidably connected to the connector housing and having a cam slot, a lever pivotably connected to the connector housing and the slide assist member, a first latching feature on the connector housing, and a second latching feature on the slide assist member; providing a second connector defining a post; inserting the post into the cam slot, thereby disengaging the first latching feature from the second latching feature; and moving the lever, thereby moving the slide assist member relative to the connector housing from a pre-staged location to a staged location and drawing the first connector together with the second connector.

### BRIEF DESCRIPTION OF THE DRAWINGS

Embodiments of the present invention will now be described by way of example with reference to the accompanying drawings, in which:

FIG. 1 shows a side view of the connector system having a first connector and a corresponding mating second connector according to some embodiments.

FIG. 2 shows an exploded view of the first connector according to some embodiments.

FIG. 3A shows a side view of the first connector according to some embodiments.

FIG. 3B shows a cross-section view of the first connector along the section line B-B in FIG. 3A according to some embodiments.

FIG. 3C shows a close-up of the cross-section view of FIG. 3B focusing on engagement of a retention feature according to some embodiments.

FIG. 4A shows a cross-section view of the connector along the section line C-C in FIG. 3B with the slide assist member is the pre-staged location according to some embodiments.

FIG. 4B shows a close up of the cross-section view of FIG. 4A focusing on a post of a corresponding mating connector and cam slot entrance of the slide assist member according to some embodiments.

FIG. 5 shows a cross-section view of the connector along the section line C-C in FIG. 3B with the slide assist member is the staged location according to some embodiments.

FIG. 6A shows a cross-section view of the connector along the section line B-B in FIG. 3A according to some embodiments.

FIG. 6B shows a close up of the cross-section view of FIG. 6A showing a movement of the slide assist member from the pre-staged location to a released location according to some embodiments.

FIG. 7A shows a cross-section view of the connector and mating connector along the section line A-A in FIG. 1 according to some embodiments.

FIG. 7B shows a close up of the cross-section view of FIG. 7A focusing on a curved ramp on the retention feature configured to disengage the retention feature as shown in FIG. 3C according to some embodiments.

FIG. 7C shows a close up of the cross-section view of FIG. 6A showing disengagement of the retention feature according to some embodiments.

FIG. 8 shows a flow chart of a method of assembling a connector system according to some embodiments.

### DETAILED DESCRIPTION

This disclosure describes non-limiting examples of a connector, particularly an electrical connector in the illustrated examples, having a retention feature for a lever and slide mating assist mechanism which is configured to withstand high applied forces.

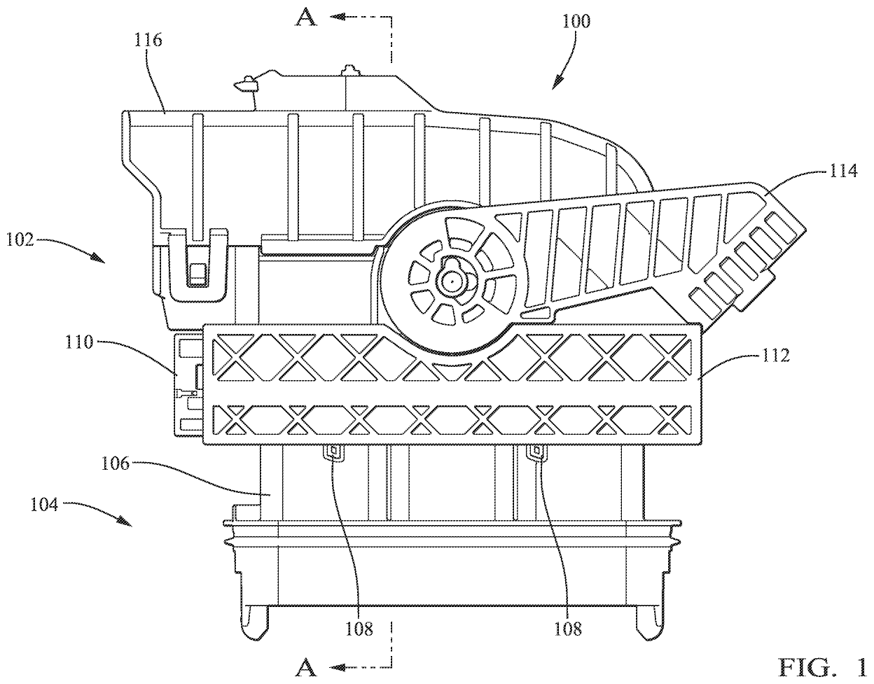

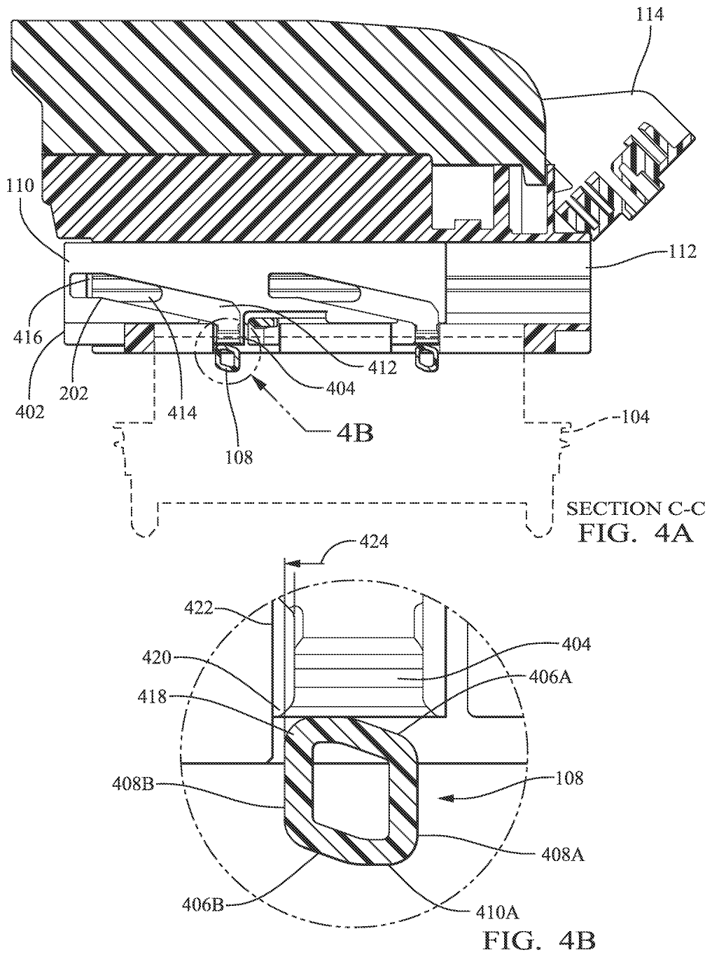

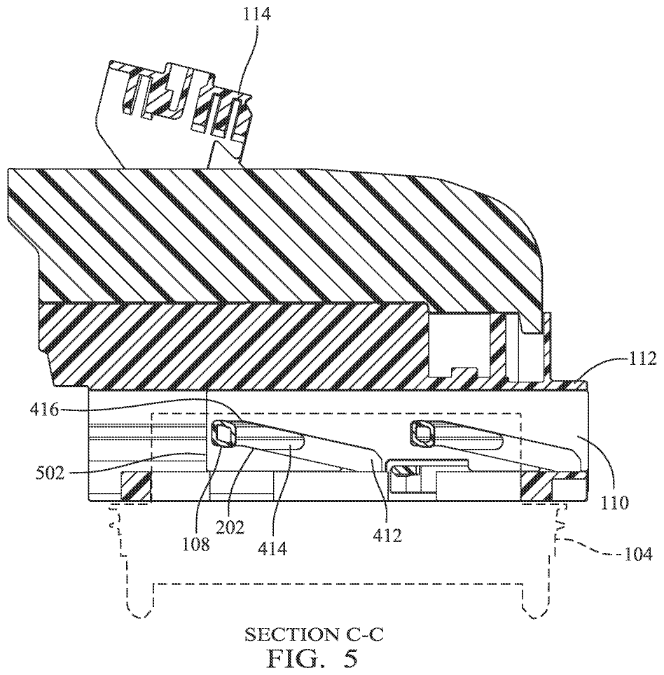

FIG. 1 shows a side view of an electrical connector system 100 according to one embodiment that has a first connector 102 and a corresponding mating second connector 104. A shroud 106 of the second connector 104 defines posts 108 that secure the second connector 104 to the first connector 102. The first connector 102 includes slide assist members 110 slidably connected to a connector housing 112 of the first connector 102 and a lever 114 pivotably connected to the connector housing 112 and the slide assist members 110. The lever 114 is configured to move the slide assist members 110 relative to the connector housing 112 from a pre-staged location 402 (see FIG. 4A) to a staged location 502 (see FIG. 5). This movement of the slide assist members 110 by the lever 114 draws the first connector 102 together with the second connector 104. The first connector 102 also includes a wire dress cover 116 configured to manage wire cables (not shown) that are attached to terminals (not shown) located within the first connector 102. The second connector 104 also includes mating terminals (not shown) configured to interface with the terminals in the first connector 102.

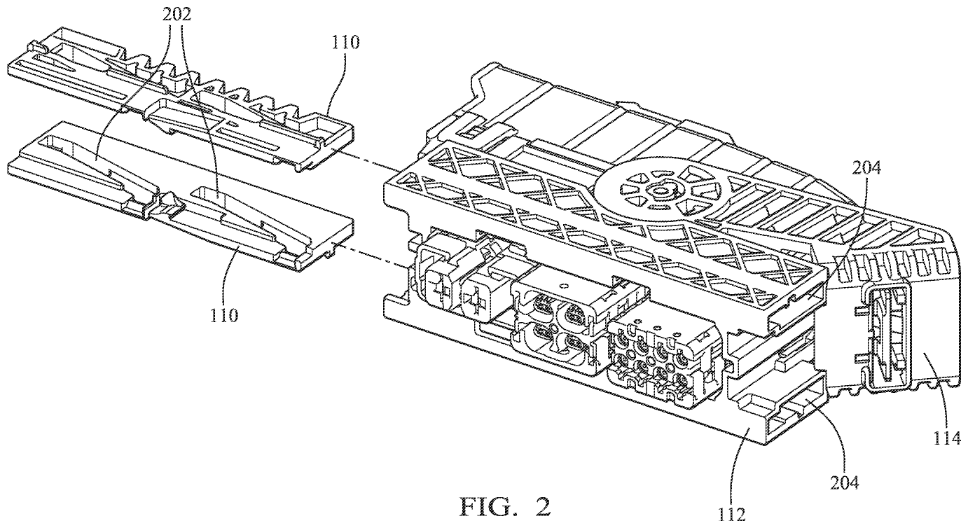

FIG. 2 shows an exploded view of the first connector 102. Each of the slide assist members 110 define a number of cam slots 202 that are configured to receive the posts 108 located on the shroud 106 of the second connector 104. The cam slots 202 may be curved or define a path that is not entirely linear in a single direction. The slide assist members 110 are inserted into channels 204 in the connector housing 112. Preferably, the slide assist members 110 may be inserted into the channels 204 from either end of the connector housing 112. The posts 108 move through the cam slots 202 as the lever 114 moves the slide assist members 110 from the pre-staged location 402 (shown in FIG. 4A) to the staged location 502 (shown in FIG. 5). The curvature of the cam slots 202 draws the first and second connectors 102, 104 together. The first and second connectors 102, 104 are also disconnected from one another by rotating the lever in the opposite direction, thereby moving the slide assist members 110 from the staged location 502 to the pre-staged location 402.

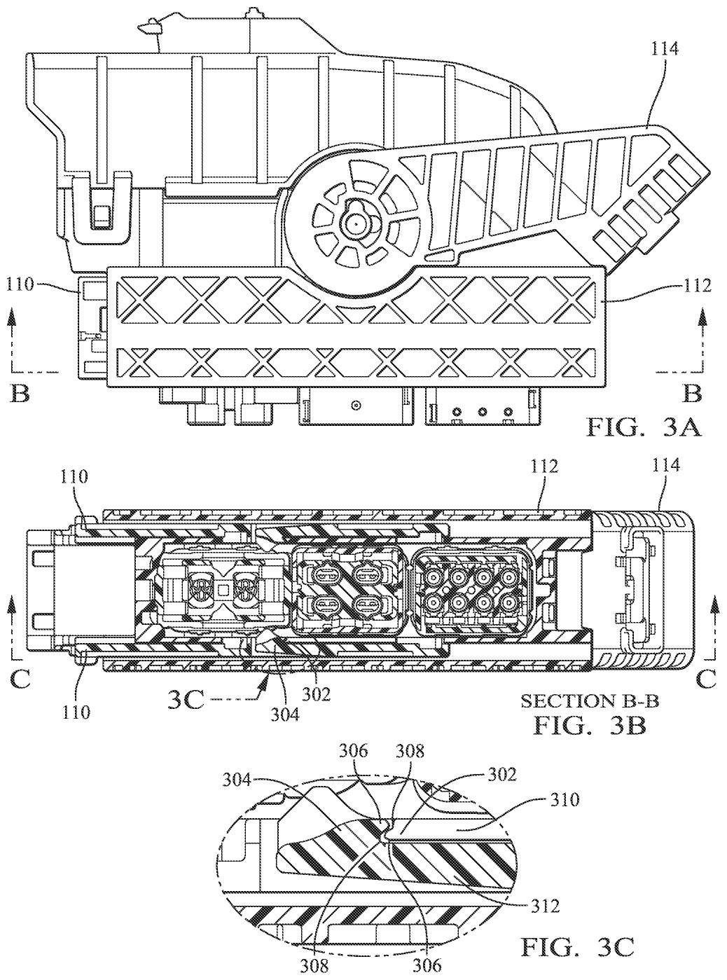

FIG. 3A shows a side view of the first connector 102. Further, FIG. 3B shows a cross-section view of the first connector 102 along the section line B-B shown in FIG. 3A. As can be seen in FIG. 3B, the first connector 102 includes a first latching feature 302 on the connector housing 112 and a second latching feature 304 on the slide assist member 110. These first and second latching features 302, 304 cooperate to maintain the slide assist members 110 in the pre-staged location 402 until the posts 108 are received in the cam slots 202. The ends of the first and second latching features 302, 304 are hook-shaped. Each of these ends include a convex portion 306 and a concave portion 308 arranged adjacent to one another. The first latching feature 302 includes a rigid latch 310 and the second latching feature 304 includes a flexible and resilient latching arm 312 having the form of a tapered cantilever beam.

As shown in FIG. 3C, when the first and second latching features 302, 304 are engaged, the convex portion 306 of the first latching feature 302 is received in the concave portion 308 of the second latching feature 304 and the convex portion 306 of the second latching feature 304 is received in the concave portion 308 of the first latching feature 302 after the slide assist members 110 are instead into the channels 204. In the illustrated example, the slide assist members 110 are preferable instead into the channels 204 from the left side of the connector housing 112 as shown in FIG. 2. The first and second latching features 302, 304 are engaged when the slide assist members 110 are in their pre-staged location 402.

FIG. 4A shows a cross-section view of the first connector 102 along the section line C-C in FIG. 3B while the slide assist member 110 is the pre-staged location 402 and the posts 108 of the second connector 104 are arranged in the opening 404 of the cam slots 202 in the slide assist members 110. The posts 108 each have a cross section with a rounded irregular concave hexagonal shape in which opposite angles of the irregular concave hexagon are congruent, i.e., have equal angular values. The posts 108 are shaped so that each set of opposed surfaces 406A and 406B, 408A and 408B, and 410A and 410B are configured to be aligned with one of the three different sections 412, 414, 416 of the cam slots respectively as the posts 108 move through the cam slots 202 while the slide assist members 110 move between the pre-staged location 402 and the staged location 502. Surfaces 406A and 406B are generally parallel to the inner walls of the cam slots 202 in section 412, surfaces 408A and 408B are generally parallel to the inner walls in section 414, and surfaces 410A and 410B are generally parallel to the inner walls in section 416.

FIG. 4B shows that the opening 404 of the cam slots 202 is chamfered. When the slide assist members 110 are arranged in the pre-staged location 402, a rounded corner 418 of the post 108 contacts the chamfered surface 420 as it enters the cam slot 202 and pushes the slide assist members 110 from the pre-staged location 402 to a released location 422 by moving it a distance 424.

FIG. 5 shows a cross-section view of the first connector 102 along the section line C-C in FIG. 3B while the slide assist member 110 is the staged location 402 and the posts 108 of the second connector 104 are arranged near an end 504 of the cam slots 202 in the slide assist members 110 due to movement of the lever 114 to its locked position. The first and second connectors 102, 104 are fully connected and mated in this condition.

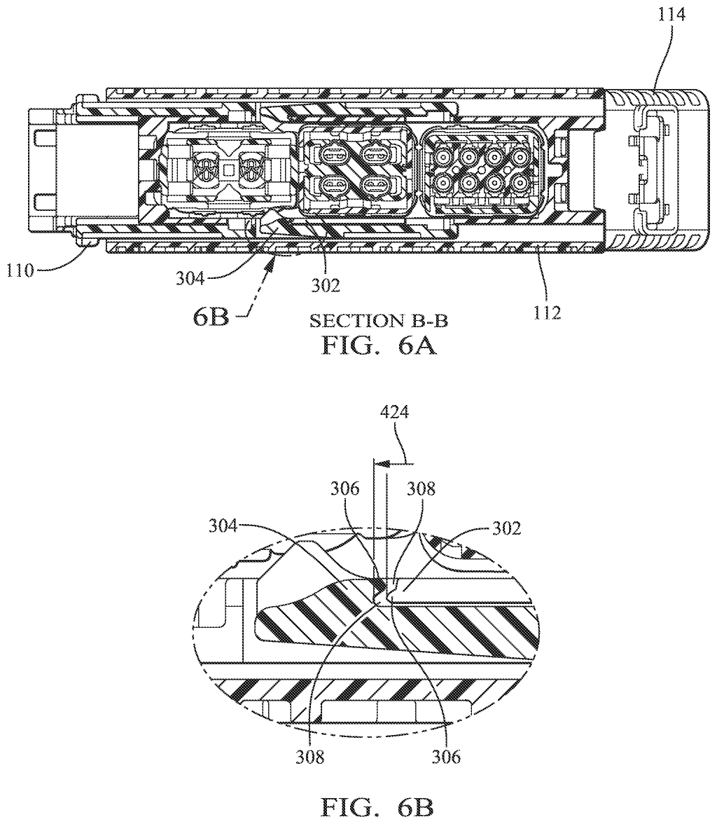

FIGS. 6A and 6B illustrate a cross section views of the first connector 102 along the section line B-B in FIG. 3A. As shown in FIGS. 6A and 6B, the slide assist members 110 are in the released location 422 and the convex portion 306 of the first latching feature 302 has moved the distance 424 relative to the concave portion 308 of the second latching feature 304 due to the interaction of the rounded corner 418 of the post 108 with the chamfered surface 420 of the slide assist members 110, thereby removing the convex portion 306 of the second latching feature 304 from the concave portion 308 of the first latching feature 302. The movement of the slide assist members 110 by the distance 424 disengages the first and second latching features 302, 304. and allows the lever 114 to move the slide assist members 110 from the pre-staged location 402 to the staged location 502.

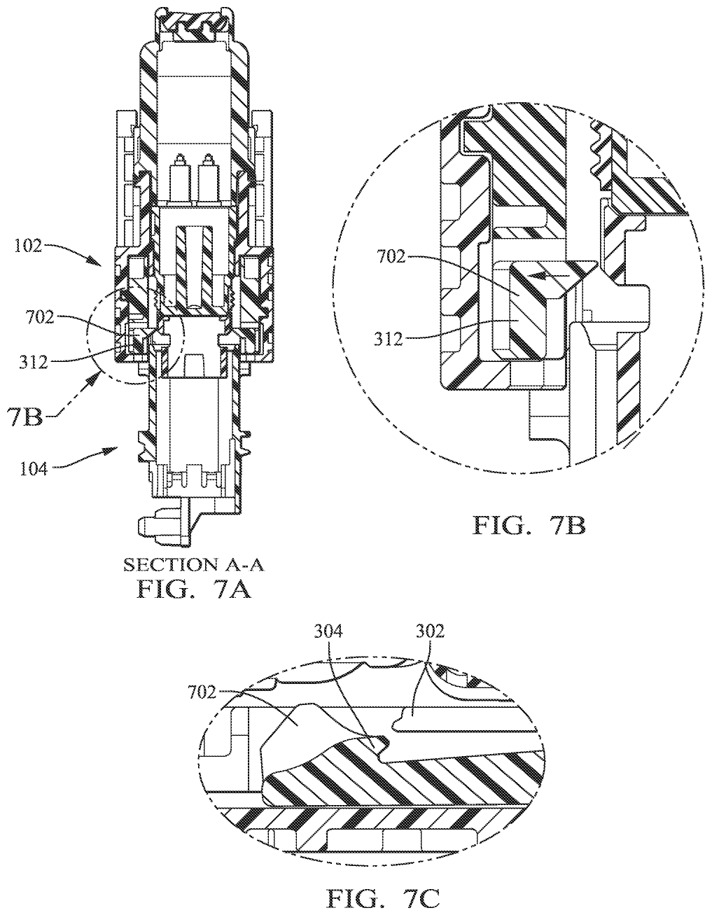

FIG. 7A shows a cross-section view of the first and second connectors 102, 104 along the section line A-A in FIG. 1. FIG. 7B shows a close up of the cross-section view of FIG. 7A focusing on a curved ramp 702 on the flexible latching arm 312 that is configured to contact the post 108 as it is received in the cam slot 202, thereby flexing the flexible latching arm 312 out of engagement with the rigid latch 310 as shown in FIG. 7C.

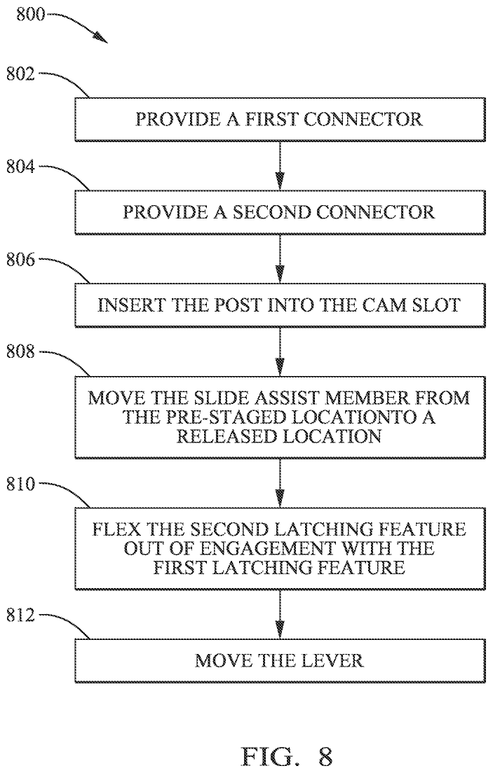

A method 800 of assembling a connector system 100 is shown in FIG. 8. The method 800 includes the steps of:

At STEP 802, a first connector is provided. In some embodiments, this step includes providing a first connector 102 having a connector housing 112 and a slide assist member 110 slidably inserted within channels 204 in the connector housing 112 thereby engaging latching tabs 302, 304. The slide assist member 110 has a cam slot 202. The cam slot 202 may be curved or define a path that is not entirely linear in a single direction. The first connector 102 also includes a lever 114 pivotably connected to the connector housing 112 and the slide assist member 110, a first latching feature 302 on the connector housing 112, and a second latching feature 304 on the slide assist member 110. The first latching feature 302 is received in the second latching feature 304 when the slide assist member 110 is inserted within channels 204. In some embodiments, this step includes receiving the convex portion 306 of the first latching feature 302 in the concave portion 308 of the second latching feature 304 and receiving the convex portion 306 of the second latching feature 304 in the concave portion 308 of the first latching feature 302 when the slide assist member 110 is in the pre-staged location 402.

At STEP 804, a second connector is provided. In some embodiments, this step includes providing a second connector 104 defining a post 108.

At STEP 806, the post is inserted into the cam slot. In some embodiments, this step includes inserting the post 108 into the cam slot 202, thereby disengaging the first latching feature 302 from the second latching feature 304.

At STEP 808, the slide assist member is moved from the pre-staged location to a released location. In some embodiments, this step includes moving the slide assist member 110 from the pre-staged location 402 to a released location 422 as the post 108 is received within the cam slot 202, thereby removing the convex portion 306 of the first latching feature 302 from the concave portion 308 of the second latching feature 304 and removing the convex portion 306 of the second latching feature 304 from the concave portion 308 of the first latching feature 302.

In some embodiments, the second latching feature 304 defines a curved ramp 702. At STEP 810, the second latching feature is flexed out of engagement with the first latching feature. In some embodiments, this step includes flexing the second latching feature 304 out of engagement with the first latching feature 302 due to contact between the ramp 702 and the post 108 as the post 108 is received in the cam slot 202.

At STEP 812, the lever is moved. In some embodiments, this step includes moving the lever 114, thereby moving the slide assist member 110 relative to the connector housing 112 from a pre-staged location 402 to a staged location 502 and drawing the first connector 102 together with the second connector 104. In some embodiments, the first and second latching features 302, 304 each include a convex portion 306 and a concave portion 308 adjacent to one another.

In some embodiments, the first connector 102 includes a first electrical terminal and the second connector 104 includes a second electrical terminal that is configured to mate with the first electrical terminal. In some embodiments, the slide assist member 110 slidably defines several instances of the cam slot 202. In some embodiments, the second connector 104 defines several instances of the post 108.

While the examples presented herein is directed to electrical connectors, alternative embodiments of the connector may be envisioned that are configured to interconnect fiber optic cables, pneumatic tubes, hydraulic tubes, or a hybrid connector having a combination of any of these types of conductors.

### Discussion of Possible Embodiments

The following are non-exclusive descriptions of possible embodiments of the present invention.

In some aspects, the techniques described herein relate to a connector assembly, including: a first connector having a connector housing; a slide assist member slidably connected to the connector housing and having a cam slot; a lever pivotably connected to the connector housing and the slide assist member configured to move the slide assist member relative to the connector housing from a pre-staged location to a staged location; and a first latching feature and a second latching feature that cooperate to maintain the slide assist member in the pre-staged location.

The assembly of the preceding paragraph can optionally include, additionally and/or alternatively any, one or more of the following features, configurations and/or additional components.

In some aspects, the techniques described herein relate to a connector assembly, wherein the first latching feature includes a rigid latch and wherein the second latching feature includes a flexible latching arm.

In some aspects, the techniques described herein relate to a connector assembly, wherein the first latching feature is defined by the connector housing and the second latching feature is defined by the slide assist member.

In some aspects, the techniques described herein relate to a connector assembly, wherein the first and second latching features each include a convex portion and a concave portion adjacent to one another, wherein the convex portion of the first latching feature is received in the concave portion of the second latching feature and the convex portion of the second latching feature is received in the concave portion of the first latching feature when the slide assist member is in the pre-staged location.

In some aspects, the techniques described herein relate to a connector assembly, wherein the flexible latching arm defines a curved ramp configured to flex the flexible latching arm out of engagement with the rigid latch due to contact between the ramp and the post as the post is received in the cam slot.

In some aspects, the techniques described herein relate to a connector assembly, wherein the connector housing defines a terminal cavity and wherein the connector assembly further includes an electrical terminal disposed in the terminal cavity.

In some aspects, the techniques described herein relate to a connector assembly, wherein the slide assist member slidably defines a plurality of the cam slot.

In some aspects, the techniques described herein relate to a connector system, including: a first connector having a connector housing; a second connector configured to mate with the first connector, the second connector defining a post; a slide assist member slidably connected to the connector housing and having a cam slot configured to receive the post; a lever pivotably connected to the connector housing and the slide assist member configured to move the slide assist member relative to the connector housing from a pre-staged location to a staged location, wherein movement of the slide assist member by the lever from the pre-staged location to the staged location draws the first connector together with the second connector; and a first latching feature and a second latching feature that cooperate to maintain the slide assist member in the pre-staged location until the post is received in the cam slot.

The system of the preceding paragraph can optionally include, additionally and/or alternatively any, one or more of the following features, configurations and/or additional components.

In some aspects, the techniques described herein relate to a connector system, wherein the first latching feature includes a rigid latch and wherein the second latching feature includes a flexible latching arm.

In some aspects, the techniques described herein relate to a connector system, wherein the first latching feature is defined by the connector housing and the second latching feature is defined by the slide assist member.

In some aspects, the techniques described herein relate to a connector system, wherein the first and second latching features each include a convex portion and a concave portion adjacent to one another, wherein the convex portion of the first latching feature is received in the concave portion of the second latching feature and the convex portion of the second latching feature is received in the concave portion of the first latching feature when the slide assist member is in the pre-staged location.

In some aspects, the techniques described herein relate to a connector system, wherein the post moves the slide assist member from the pre-staged location to a released location, thereby removing the convex portion of the first latching feature from the concave portion of the second latching feature and removing the convex portion of the second latching feature from the concave portion of the first latching feature.

In some aspects, the techniques described herein relate to a connector system, wherein the post has a cross section with a rounded irregular concave hexagonal shape in which opposite angles are congruent.

In some aspects, the techniques described herein relate to a connector system, wherein the flexible latching arm defines a curved ramp configured to contact the post as it is received in the cam slot, thereby flexing the flexible latching arm out of engagement with the rigid latch.

In some aspects, the techniques described herein relate to a connector system, wherein the first connector includes a first electrical terminal and wherein the second connector includes a second electrical terminal configured to mate with the first electrical terminal.

In some aspects, the techniques described herein relate to a connector system, wherein the slide assist member slidably defines a plurality of the cam slot and wherein the second connector defines a plurality of the post.

In some aspects, the techniques described herein relate to a method of assembling a connector system, including: providing a first connector having a connector housing, a slide assist member slidably connected to the connector housing and having a cam slot, a lever pivotably connected to the connector housing and the slide assist member, a first latching feature on the connector housing, and a second latching feature on the slide assist member; providing a second connector defining a post; inserting the post into the cam slot, thereby disengaging the first latching feature from the second latching feature; and moving the lever, thereby moving the slide assist member relative to the connector housing from a pre-staged location to a staged location and drawing the first connector together with the second connector.

The method of the preceding paragraph can optionally include, additionally and/or alternatively any, one or more of the following features, configurations and/or additional components.

In some aspects, the techniques described herein relate to a method, wherein first and second latching features each include a convex portion and a concave portion adjacent to one another, wherein the method further includes: receiving convex portion of the first latching feature in the concave portion of the second latching feature and receiving the convex portion of the second latching feature in the concave portion of the first latching feature when the slide assist member is in the pre-staged location; and moving the slide assist member from the pre-staged location to a released location as the post is received within the cam slot, thereby removing the convex portion of the first latching feature from the concave portion of the second latching feature and removing the convex portion of the second latching feature from the concave portion of the first latching feature.

In some aspects, the techniques described herein relate to a method, wherein the second latching feature defines a curved ramp and wherein the method further includes flexing the second latching feature out of engagement with the first latching feature due to contact between the ramp and the post as the post is received in the cam slot.

In some aspects, the techniques described herein relate to a method, wherein the first connector includes a first electrical terminal, wherein the second connector includes a second electrical terminal configured to mate with the first electrical terminal, wherein the slide assist member slidably defines a plurality of the cam slot, and wherein the second connector defines a plurality of the post.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A connector assembly, comprising:
a first connector having a connector housing;
a slide assist member slidably connected to the connector housing and having a cam slot;
a lever pivotably connected to the connector housing and the slide assist member configured to move the slide assist member relative to the connector housing from a pre-staged location to a staged location; and
a first latching feature and a second latching feature that cooperate to maintain the slide assist member in the pre-staged location.

2. The connector assembly according to claim 1, wherein the first latching feature comprises a rigid latch and wherein the second latching feature comprises a flexible latching arm.

3. The connector assembly according to claim 2, wherein the first latching feature is defined by the connector housing and the second latching feature is defined by the slide assist member.

4. The connector assembly according to claim 2, wherein the first and second latching features each include a convex portion and a concave portion adjacent to one another, wherein the convex portion of the first latching feature is received in the concave portion of the second latching feature and the convex portion of the second latching feature is received in the concave portion of the first latching feature when the slide assist member is in the pre-staged location.

5. The connector assembly according to claim 4, wherein the flexible latching arm defines a curved ramp configured to flex the flexible latching arm out of engagement with the rigid latch.

6. The connector assembly according to claim 1, wherein the connector housing defines a terminal cavity and wherein the connector assembly further comprises an electrical terminal disposed in the terminal cavity.

7. The connector assembly according to claim 1, wherein the slide assist member slidably defines a plurality of the cam slot.

8. A connector system, comprising:
a first connector having a connector housing;
a second connector configured to mate with the first connector, the second connector defining a post;
a slide assist member slidably connected to the connector housing and having a cam slot configured to receive the post;
a lever pivotably connected to the connector housing and the slide assist member configured to move the slide assist member relative to the connector housing from a pre-staged location to a staged location, wherein movement of the slide assist member by the lever from the pre-staged location to the staged location draws the first connector together with the second connector; and
a first latching feature and a second latching feature that cooperate to maintain the slide assist member in the pre-staged location until the post is received in the cam slot.

9. The connector system according to claim 8, wherein the first latching feature comprises a rigid latch and wherein the second latching feature comprises a flexible latching arm.

10. The connector system according to claim 9, wherein the first latching feature is defined by the connector housing and the second latching feature is defined by the slide assist member.

11. The connector system according to claim 9, wherein the first and second latching features each include a convex portion and a concave portion adjacent to one another, wherein the convex portion of the first latching feature is received in the concave portion of the second latching feature and the convex portion of the second latching feature is received in the concave portion of the first latching feature when the slide assist member is in the pre-staged location.

12. The connector system according to claim 11, wherein the post moves the slide assist member from the pre-staged location to a released location, thereby removing the convex portion of the first latching feature from the concave portion of the second latching feature and removing the convex portion of the second latching feature from the concave portion of the first latching feature.

13. The connector system according to claim 12, wherein the post has a cross section with a rounded irregular concave hexagonal shape in which opposite angles are congruent.

14. The connector system according to claim 11, wherein the flexible latching arm defines a curved ramp configured to contact the post as it is received in the cam slot, thereby flexing the flexible latching arm out of engagement with the rigid latch.

15. The connector system according to claim 8, wherein the first connector comprises a first electrical terminal and wherein the second connector comprises a second electrical terminal configured to mate with the first electrical terminal.

16. The connector system according to claim 8, wherein the slide assist member slidably defines a plurality of the cam slot and wherein the second connector defines a plurality of the post.

17. A method of assembling a connector system, comprising:
providing a first connector having a connector housing, a slide assist member slidably connected to the connector housing and having a cam slot, a lever pivotably connected to the connector housing and the slide assist member, a first latching feature on the connector housing, and a second latching feature on the slide assist member;
providing a second connector defining a post;
inserting the post into the cam slot, thereby disengaging the first latching feature from the second latching feature; and
moving the lever, thereby moving the slide assist member relative to the connector housing from a pre-staged location to a staged location and drawing the first connector together with the second connector.

18. The method according to claim 17, wherein first and second latching features each include a convex portion and a concave portion adjacent to one another, wherein the method further includes:
receiving the convex portion of the first latching feature in the concave portion of the second latching feature and receiving the convex portion of the second latching feature in the concave portion of the first latching feature when the slide assist member is in the pre-staged location; and
moving the slide assist member from the pre-staged location to a released location as the post is received within the cam slot, thereby removing the convex portion of the first latching feature from the concave portion of the second latching feature and removing the convex portion of the second latching feature from the concave portion of the first latching feature.

19. The method according to claim 18, wherein the second latching feature defines a curved ramp and wherein the method further comprises flexing the second latching feature out of engagement with the first latching feature due to contact between the ramp and the post as the post is received in the cam slot.

20. The method according to claim 18, wherein the first connector comprises a first electrical terminal, wherein the second connector comprises a second electrical terminal configured to mate with the first electrical terminal, wherein the slide assist member slidably defines a plurality of the cam slot, and wherein the second connector defines a plurality of the post.
